(19) United States
(12) Patent Application Publication
(10) Pub. No.: US 2011/0222025 A1
(43) Pub. Date: Sep. 15, 2011

(54) ILLUMINATION OPTICAL DEVICE AND PROJECTION DISPLAY DEVICE USING THE ILLUMINATION OPTICAL DEVICE

(75) Inventor: Hirokazu SAKAGUCHI, Osaka (JP)

(73) Assignee: PANASONIC CORPORATION, Osaka (JP)

(21) Appl. No.: 13/037,320

(22) Filed: Feb. 28, 2011

(30) Foreign Application Priority Data
Mar. 12, 2010 (JP) 2010-055733

(51) Int. Cl. G03B 21/26; G02B 6/00

(52) U.S. Cl. 353/94; 362/551

(57) ABSTRACT

A light guiding section guides, to a light incident surface of a rod integrator, a portion of light beams incident on a first light incident surface, and emits another portion of the light beams from a second light incident surface. The light guiding section guides, to the light incident surface of the rod integrator, a portion of light beams incident on the second light incident surface, and emits another portion of the light beams from the first light incident surface. A first light converging section converges light beams which are emitted from the first light incident surface such that a converged light is incident on the first light incident surface. A second light converging section converges light beams which are emitted from the second light incident surface such that a converged light is incident on the second light incident surface.

### CROSS REFERENCE TO RELATED APPLICATION

The disclosure of Japanese Patent Application No. 2010-055733, filed on Mar. 12, 2010, is incorporated herein by reference.

### BACKGROUND OF THE INVENTION

1. Field of the Invention

The present invention relates to an illumination optical device for use in a projection display device, and more particularly to a technique for improving a light converging efficiency when light beams emitted from a plurality of light sources are synthesized.

2. Description of the Background Art

In recent years, projection display devices such as liquid crystal projectors and DLP (Digital Light Processing) projectors are becoming wide-spread.

The projection display device is required to brighten a projected image. Therefore, a light source, such as a high pressure mercury lamp, a metal halide lamp, and a xenon lamp, which has a relatively high luminance is mainly used for the projection display device. Further, power to be supplied to a light source can be increased in order to improve brightness of a projected image. However, increase of power to be supplied to each lamp leads to reduction of the life of the lamp.

Therefore, a plurality of lamps each of which is relatively low in power consumption are used, and light beams emitted from the plurality of lamps are synthesized. Thus, the brightness of the projected image can be efficiently improved so as to prevent reduction of the life of each lamp.

Moreover, the projection display device is required to make the projected image uniform. A method using a lens array and a method using a rod integrator for ensuring the uniformity in projected image are known. For example, Japanese Patent No. 3448223(B2) (Patent Document 1) discloses a light source device which improves brightness of a projected image and ensures the uniformity in the projected image by using two light sources, two reflectors, and one rod integrator.

In the light source device disclosed in Patent Document 1, light beams are emitted from the two light sources, and the light beams from each of the two light sources are converged by a corresponding one of the reflectors, and enter a corresponding one of light incident surfaces of the rod integrator. The light incident on one of the light incident surfaces is totally reflected, multiple times, by the other of the light incident surfaces and side surfaces of the rod integrator. Thus, non-uniformity in illumination which has occurred when the light has entered the light incident surface is eliminated, so that uniform illumination light having a high luminance is outputted from a light exit surface of the rod integrator (see FIG. 1 of Patent Document 1).

### SUMMARY OF THE INVENTION

On the other hand, the size of the light incident surface of the rod integrator is too small for a plurality of spots of typical light sources. Therefore, the size of a light emitting device of the light source is reduced so as to reduce the size of the spot, thereby effectively improving a light converging efficiency. However, it is known that the reduction of the size of the light emitter leads to reduction of the life of the light source.

On the other hand, when the size of the rod integrator is increased, and thus the size of the light incident surface is increased, a plurality of spots of typical light sources can be placed. However, the following is known. That is, when the size of the rod integrator is increased, the size of a display device (such as a liquid crystal panel or a DMD (Digital Minor Device)) needs to be increased accordingly. Otherwise, brightness of the projected image is reduced. The increase of the size of the display device is directly linked to significant increase of cost. Therefore, this is not a favorable solution.

Further, in the light source device disclosed in Patent Document 1, only light beams which are incident on one of the light incident surfaces, and are reflected by the other of the light incident surfaces are effective. The other light beams are lost. Therefore, the proportion of the light incident surface that is substantially effective in that incident light is effectively utilized is small. Accordingly, the light converging efficiency is low for the size of the rod integrator.

Therefore, an object of the present invention is to provide an illumination optical device which can improve a light converging efficiency when light beams emitted from a plurality of lamps are synthesized, and a projection display device using the illumination optical device.

The present invention is directed to an illumination optical device, and a projection display device using the illumination optical device. In order to solve the aforementioned problems, the illumination optical device according to the present invention includes: a rod integrator for eliminating a non-uniformity in an illumination of incident light which is incident on a light incident surface of the rod integrator, and for emitting, from a light exit surface of the rod integrator, illumination light in which an illumination distribution is uniform; a light guiding section for guiding a portion of first incident light beams incident on a first light incident surface of the light guiding section, to the light incident surface of the rod integrator, and for transmitting through the light guiding section and emitting from a second light incident surface of the light guiding section another portion of the first incident light beams, and for guiding a portion of second incident light beams incident on the second light incident surface of the light guiding section, to the light incident surface of the rod integrator, and for transmitting through the light guiding section and emitting from the first light incident surface of the light guiding section another portion of the second incident light beams; a first light source and a second light source opposing each other so as to be symmetrical with respect to the light guiding section; a first light converging section for converging light beams which are directly emitted from the first light source, and for converging light beams which have been transmitted through the light guiding section and emitted from the first light incident surface such that a converged light is incident on the first light incident surface; and a second light converging section for converging light beams which are directly emitted from the second light source, and for converging light beams which have been transmitted through the light guiding section and emitted from the second light incident surface such that a converged light is incident on the second light incident surface.

Preferably, the light guiding section may include a first right-angled trapezoidal prism and a second right-angled trapezoidal prism. The first light incident surface may include a long side of a first trapezoid in the first right-angled trapezoidal prism, and the first light incident surface may be opposed to the first light source. The second light incident surface may include a long side of a second trapezoid in the second right-angled trapezoidal prism, and the second light incident surface may be opposed to the second light source. The angle between the first light incident surface, and a first reflecting surface including an oblique side of the first trapezoid, and the angle between the second light incident surface, and a second reflecting surface including an oblique side of the second trapezoid may be each almost 45 degrees. A first light exit surface including a side between right angles of the first trapezoid, and a second light exit surface including a side between right angles of the second trapezoid may be each in contact with the light incident surface of the rod integrator. A first light transmission surface including a short side of the first trapezoid and a second light transmission surface including a short side of the second trapezoid may be in contact with each other, and the portion of the first incident light beams and the portion of the second incident light beams may be transmitted through the first light transmission surface and the second light transmission surface.

Preferably, in the light guiding section, the first right-angled trapezoidal prism and the second right-angled trapezoidal prism may be integrated into one component by connecting the first light transmission surface and the second light transmission surface.

Preferably, a size of a light converging spot for each of the first light converging section and the second light converging section may be greater than half a size of the light incident surface of the rod integrator.

Preferably, the illumination optical device may further include a first reflector and a second reflector, provided on the first light incident surface and the second light incident surface, respectively, outside effective surfaces on which the incident light is effectively utilized, wherein the first reflector and the second reflector reflect light outside of the effective surfaces of the first light incident surface and the second light incident surface, respectively.

Preferably, the rod integrator may be tapered or flared such that a size of the light incident surface of the rod integrator and a size of the light exit surface of the rod integrator are different from each other.

Preferably, an illumination optical device according to the present invention may include: a plurality of illumination optical devices described above; and one main rod integrator, and the plurality of illumination optical devices may include a plurality of subsidiary rod integrators, respectively, each of which corresponds to the rod integrator described above; and light exit surfaces of the plurality of subsidiary rod integrators may be aligned, and be connected to a light incident surface of the one main rod integrator.

Preferably, at least one of the one main rod integrator and the plurality of subsidiary rod integrators is tapered or flared, and a size of a light incident surface of the at least one tapered or flared rod integrator and a size of a light exit surface of the at least one tapered or flared rod integrator may be different from each other.

Preferably, the one main rod integrator may act as one of the plurality of subsidiary rod integrators without providing the one of the plurality of subsidiary rod integrators.

Preferably, at least one of the one main rod integrator and the plurality of subsidiary rod integrators may be tapered or flared, and a size of a light incident surface of the at least one tapered or flared rod integrator and a size of a light exit surface of the at least one tapered or flared rod integrator may be different from each other.

Further, in order to solve the afore-mentioned problems, a projection display device according to the present invention is a projection display device using any one of the illumination optical devices described above.

As described above, according to the present invention, a portion of the incident light beams which are incident on the light incident surface of the light guiding section, but cannot be guided to the light incident surface of the rod integrator, are transmitted through the light guiding section, and are emitted from the light incident surface on the opposing side. The emitted light beams are converged by the light converging section on the opposing side, and are incident on the light incident surface of the light guiding section as new incident light, that is, as effective light, thereby contributing to the enhancement of the brightness.

In these features, the size of the light incident surface of the light guiding section can be increased without increasing the size of the light incident surface of the rod integrator. Therefore, light converging efficiency can be enhanced without increasing the power supplied to the light source, without reducing the life of each light source by reducing the size of a light emitting device of the light source, and without significantly increasing cost by increasing the size of the rod integrator and the size of the display device.

Further, the illumination optical device can be designed such that, even when an acute angle portion of the right-angled trapezoidal prism is chamfered to some degree, the efficiency reduction hardly occurs, thereby facilitating handling.

Further, in a case where a plurality of the illumination optical devices described above are provided, when the rod integrators of the plurality of the illumination optical devices are used as subsidiary rod integrators, and the light exit surfaces of the subsidiary rod integrators are aligned, and are connected to the light incident surface of one main rod integrator which is additionally provided, the number of the light sources can be greater than or equal to three. Therefore, the brightness of the projected image can be further enhanced without reducing the life of each light source and significantly increasing cost.

### BRIEF DESCRIPTION OF THE DRAWINGS

FIG. 1 is a diagram illustrating a main portion of an illumination optical device 1 according to a first embodiment;

FIG. 2 is an enlarged view of a rod integrator 10 and a light guiding section 20 shown in FIG. 1;

FIG. 3 is a diagram illustrating an effect of the present invention;

FIG. 4 is a diagram illustrating a main portion of an illumination optical device 2 according to a first modification;

FIG. 5 is a diagram illustrating a main portion of an illumination optical device 3 according to a second modification;

FIG. 6 is a diagram illustrating a main portion of an illumination optical device 4 according to the second modification;

FIG. 7 is a diagram illustrating a main portion of a light source unit 130 according to a third modification;

FIG. 8 is a diagram illustrating a main portion of a light guiding section 120 according to a fourth modification;

FIG. 9 is a diagram illustrating a main portion of an illumination optical device 5 according to a second embodiment;

FIG. 10 is a diagram illustrating a main portion of an illumination optical device 6 according to a fifth modification; and

FIG. 11 is a diagram illustrating a main portion of a projection display device 9 according to a third embodiment.

### DESCRIPTION OF THE PREFERRED EMBODIMENTS

### First Embodiment

### <Structure>

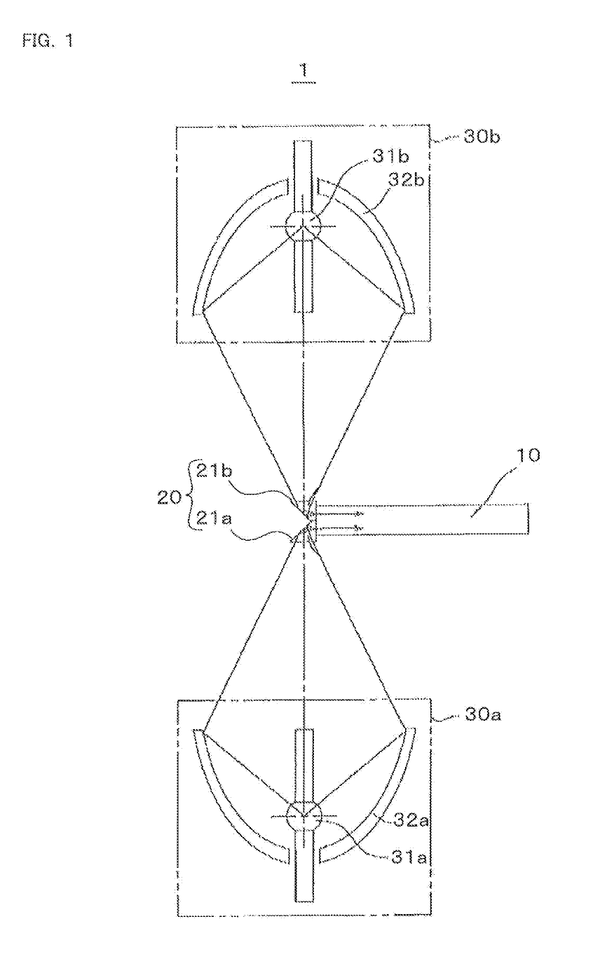

FIG. 1 is a diagram illustrating a main portion of an illumination optical device 1 according to a first embodiment.

In FIG. 1, the illumination optical device 1 includes a rod integrator 10, a light guiding section 20, a first light source unit 30a, and a second light source unit 30b.

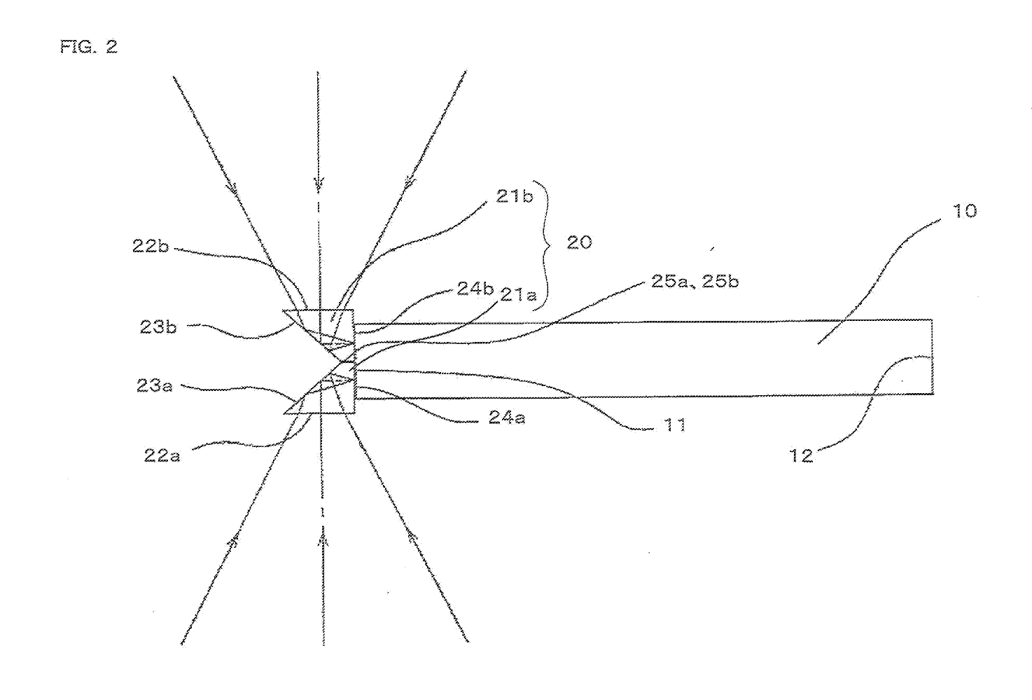

In the rod integrator 10, incident light which is incident on a light incident surface 11 (the surface on the left side in FIG. 2) of the rod integrator 10 is totally reflected in a medium multiple times, so that non-uniformity in illumination of the incident light is eliminated and illumination light having a uniform illumination distribution is emitted from a light exit surface 12 (the surface on the right side in FIG. 2) of the rod integrator.

The light guiding section 20 includes a first right-angled trapezoidal prism 21a, and a second right-angled trapezoidal prism 21b. A portion of first incident light beams incident on a first light incident surface 22a (the surface on the lower side in FIG. 2) of the first right-angled trapezoidal prism 21a is guided to the light incident surface 11 of the rod integrator 10, and another portion of the first incident light beams is transmitted through the light guiding section 20 and emitted from a second light incident surface 22b (the surface on the upper side in FIG. 2) of the second right-angled trapezoidal prism 21b. On the other hand, a portion of second incident light beams incident on the second light incident surface 22b is guided to the light incident surface 11 of the rod integrator 10, and another portion of the second incident light beams is transmitted through the light guiding section 20 and emitted from the first light incident surface 22a.

A material of each of the rod integrator 10, the first right-angled trapezoidal prism 21a, and the second right-angled trapezoidal prism 21b is preferably a silica glass from the viewpoint of heat resistance, and the material thereof is preferably BK7 or SK5 from the standpoint of cost. Thus, the material may be selected in accordance with a level of energy of emission from the light source.

The first light source unit 30a includes a first light source 31a and a first light converging section 32a. Similarly, the second light source unit 30b includes a second light source 31b and a second light converging section 32b.

Each of the first light source 31a and the second light source 31b is an electric discharge lamp, such as a high pressure mercury lamp, a metal halide lamp, and a xenon lamp, having a relatively high luminance. The first light source 31a and the second light source 31b are opposed to each other so as to be symmetrical with respect to the light guiding section 20.

Each of the first light converging section 32a and the second light converging section 32b is, for example, a concave mirror which has a cross section of which the shape is a portion of an ellipse, and has a reflecting surface formed thereon. The first light converging section 32a converges emitted light beams which are directly emitted from the first light source 31a located at a first focus, and the converged light is incident on the first light incident surface 22a of the light guiding section 20 which has a second focus at almost the center of the light guiding section 20. Further, the first light converging section 32a converges light beams which have been transmitted through the light guiding section 20 and emitted from the first light incident surface 22a, and the converged light is incident on the first light incident surface 22a. Similarly, the second light converging section 32b converges emitted light beams which are directly emitted from the second light source 31b located at a first focus, and the converged light is incident on the second light incident surface 22b of the light guiding section 20 which has a second focus at almost the center of the light guiding section 20. Further, the second light converging section 32b converges light beams which have been transmitted through the light guiding section 20 and emitted from the second light incident surface 22b, and the converged light is incident on the second light incident surface 22b.

FIG. 2 is an enlarged view of the rod integrator 10 and the light guiding section 20 shown in FIG. 1

An exemplary specific structure of the light guiding section 20 will be described with reference to FIG. 2.

The first right-angled trapezoidal prism 21a shown in FIG. 2 includes the first light incident surface 22a, a first reflecting surface 23a, a first light exit surface 24a, and a first light transmission surface 25a. Similarly, the second right-angled trapezoidal prism 21b includes the second light incident surface 22b, a second reflecting surface 23b, a second light exit surface 24b, and a second light transmission surface 25b.

The first light incident surface 22a includes a long side of a trapezoid (hereinafter, referred to as a “first trapezoid”) in the first right-angled trapezoidal prism 21a, and the first light incident surface 22a is opposed to the first light source 31a. Similarly, the second light incident surface 22b includes a long side of a trapezoid (hereinafter, referred to as a “second trapezoid”) in the second right-angled trapezoidal prism 21b, and the second light incident surface 22b is opposed to the second light source 31b. Therefore, the light incident surfaces (the first light incident surface 22a and the second light incident surface 22b) of the first right-angled trapezoidal prism 21a and the second right-angled trapezoidal prism 21b are positioned so as to be oriented in opposite facing directions.

The first reflecting surface 23a includes an oblique side of the first trapezoid. Similarly, the second reflecting surface 23b includes an oblique side of the second trapezoid. Reflection coating is formed on each of the first reflecting surface 23a and the second reflecting surface 23b.

The angle between the first reflecting surface 23a and the first light incident surface 22a, and the angle between the second reflecting surface 23b and the second light incident surface 22b are each about 45 degrees. Light incident from the light source unit can be bent by 90 degrees and guided to the rod integrator.

When the right-angled trapezoidal prism is made of a material having a high refractivity (refractivity n=1.7 or greater), the reflecting surfaces (the first reflecting surface 23a, and the second reflecting surface 23b) enable total reflection. In this case, the reflection coating may not be formed.

The first light exit surface 24a includes a side between right angles of the first trapezoid. Similarly, the second light exit surface 24b includes a side between right angles of the second trapezoid. The first light exit surface 24a and the second light exit surface 24b are adjacent to the light incident surface 11 of the rod integrator 10.

The first light transmission surface 25a includes a short side of the first trapezoid. Similarly, the second light transmission surface 25b includes a short side of the second trapezoid. The first light transmission surface 25a and the second light transmission surface 25b are in contact with each other, and transmit therethrough the portion of the first incident light beams incident on the first light incident surface 22a and the portion of the second incident light beams incident on the second light incident surface 22b.

The position at which light beams emitted from the first light source unit 30a are converged is preferably set in an optical path from the first light incident surface 22a to the first light exit surface 24a, and the position at which light beams emitted from the second light source unit 30b are converged is preferably set in an optical path from the second light incident surface 22b to the second light exit surface 24b.

The size of each of the first light exit surface 24a and the second light exit surface 24b is set so as to be greater than half the size of the light incident surface 11 of the rod integrator 10. Therefore, the first right-angled trapezoidal prism 21a and the second right-angled trapezoidal prism 21b can be mechanically held in ranges outside effective ranges. The effective ranges represent ranges in which the incident light can be effectively utilized. Further, in this case, the position at which light beams emitted from the first light source unit 30a are converged is preferably near the first light exit surface 24a, and similarly the position at which light beams emitted from the second light source unit 30b are converged is preferably near the second light exit surface 24b.

Moreover, the size of light converging spot for each of the first light converging section and the second light converging section can be set so as to be greater than half the size of the light incident surface 11 of the rod integrator 10. The size of the light converging spot is defined by an area on which 80% of the entirety of energy of the light beams can be captured.

The size of each of the first light exit surface 24a and the second light exit surface 24b may be set so as to be equal to half the size of the light incident surface 11 of the rod integrator 10. However, chipping of the acute angle portion (45 degrees) of each right-angled trapezoidal prism may cause a reduction in efficiency. Therefore, sufficient attention should be paid for handling when, for example, the right-angled trapezoidal prisms are fixed. Further, in this case, the position at which light beams emitted from the first light source unit 30a are converged is preferably set in an optical path from the first light incident surface 22a to the first reflecting surface 23a, and the position at which light beams emitted from the second light source unit 30b are converged is preferably set in an optical path from the second light incident surface 22b to the second reflecting surface 23b.

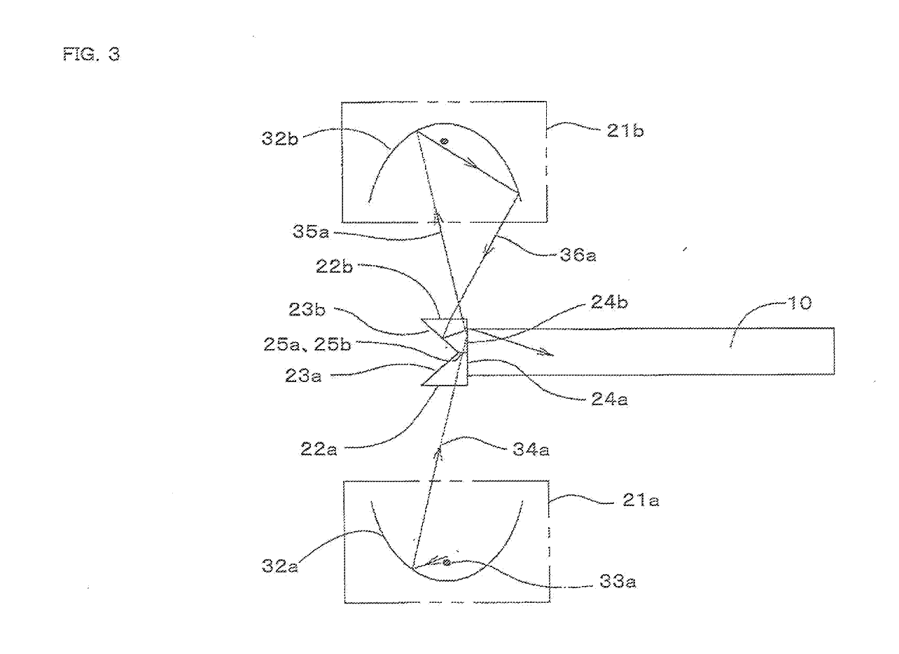

FIG. 3 is a diagram illustrating an effect of the present invention. Light beams 34a, which are a portion of light beams emitted from the first light source unit 30a other than a light source center 33a, are incident on the first light incident surface 22a, transmitted through the first light transmission surface 25a and the second light transmission surface 25b (may be further totally reflected by the first light exit surface 24a or the second light exit surface 24b, in some cases) without reaching the first reflecting surface 23a, and emitted from the second light incident surface 22b as light beams 35a. The light beams 35a are transmitted toward the opposing second light source unit 30b, reflected twice by the concave mirror of the second light converging section 32b, and transmitted as light beams 36a. The light beams 36a are incident on the second light incident surface 22b, and a portion of the light beams 36a are reflected by the second reflecting surface 23b into the rod integrator 10, and another portion of the light beams 36a are transmitted, multiple times, through a course as described above, and may be guided to the rod integrator 10 with a certain probability.

In the structure according to the present embodiment, since the light beams which have not been used are reused, an amount of light beams which are guided to the rod integrator can be increased.

Therefore, the size of the light incident surface of the light guiding section can be increased without increasing the size of the light incident surface of the rod integrator, so that the light converging efficiency can be improved without forcibly reducing the size of the light converging spot.

### <Examination of Effect>

Table 1 indicates a result of calculating the effective number of light beams emitted from the light exit surface of the rod integrator when ten thousand light beams are emitted from the light source in each of the conventional art and the structure according to the present embodiment.

TABLE 1

| | |
|---|---|
| Structure of Patent Document 1 | 6770 light beams |
| Structure of present embodiment (FIG. 1) | 7206 light beams |
| In a case where no opposing light sources are | 6840 light beams |
| used in the structure of the present | |
| embodiment (FIG. 1) | |

In this exemplary case, a high pressure mercury lamp is used as a light source, and the length of an arc is 1.2 mm. Further, the size of the cross-section of the rod integrator is 6 mm×8 mm.

According to Table 1, the effective number of light beams having been obtained in the structure according to the present embodiment is 1.064 times (=7206/6770) greater than that in the conventional art. Further, when the opposing light sources are provided to reuse the light beams, the effective number of light beams is increased so as to be 1.053 times (=7206/6840) greater than those obtained when opposing light sources are not used.

Although, in the present embodiment, the light guiding section 20 is formed as two right-angled trapezoidal prisms, the first right-angled trapezoidal prism 21a and the second right-angled trapezoidal prism 21b may be integrated into one component by connecting the first light transmission surface 25a and the second light transmission surface 25b.

Further, the optimal angle between the first reflecting surface 23a and the first light incident surface 22a, and the optimal angle between the second reflecting surface 23b and the second light incident surface 22b are each 45 degrees. However, the angle need not necessarily be 45 degrees. When the angle is other than 45 degrees, the same effect can be obtained. Moreover, the prism may have a shape different than a right-angled trapezoid, which enables a similar effect to be obtained.

[First Modification]

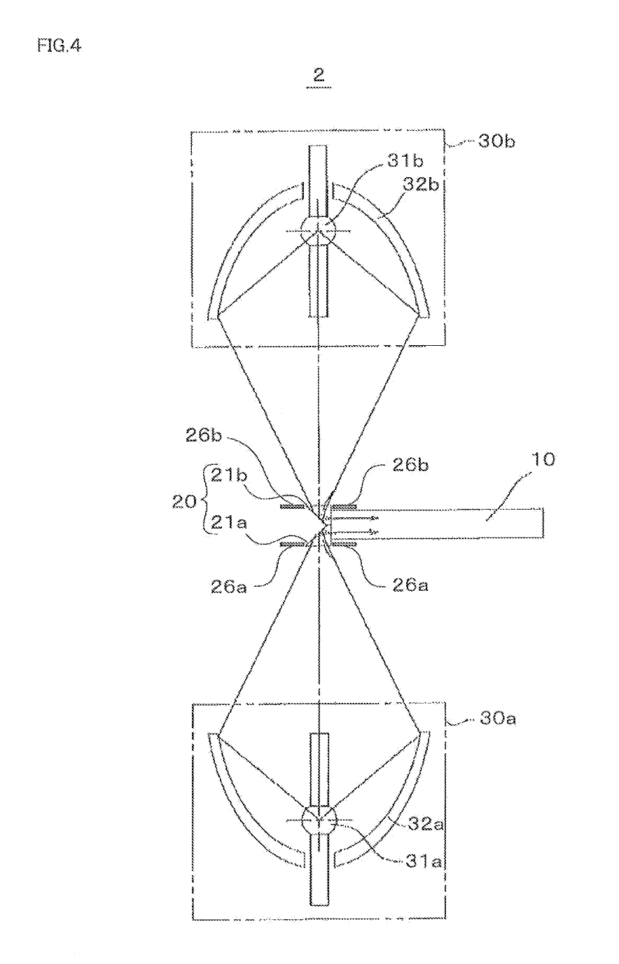

FIG. 4 is a diagram illustrating a main portion of an illumination optical device 2 according to a first modification.

As shown in FIG. 4, the illumination optical device 2 according to the first modification includes, in addition to the components of the illumination optical device 1, a first reflector 26a and a second reflector 26b. The first reflector 26a and the second reflector 26b are provided on the first light incident surface 22a and the second light incident surface 22b, respectively, outside the effective surfaces on which the incident light can be effectively utilized, and, consequently, reflect light beams outside of the effective surfaces.

A light beam reflected by the first reflector 26a travels toward the first light source 31a, and increases the temperature of a light emitting section of the first light source 31a, thereby contributing to improvement of light emitting efficiency. Similarly, a light beam reflected by the second reflector 26b travels toward the second light source 31b, and increases the temperature of a light emitting section of the second light source 31b, thereby contributing to improvement of light emitting efficiency.

The reflector may be made of, for example, aluminium which has mirror coating formed thereon and which has a high luminance.

[Second Modification]

An aspect ratio of a screen of a projection display device should be almost equal to an aspect ratio of the light exit surface of the rod integrator. However, an aspect ratio of the light incident surface of the rod integrator may vary depending on a result of efficiency calculation.

For example, when the aspect ratio of the projection display device is 3:4 (vertical dimension:horizontal dimension), the size of an aperture of the light incident surface of the rod integrator assigned to one light source indicates an aspect ratio of 3:2 (vertical dimension:horizontal dimension). However, such a size of the aperture of the light incident surface of the rod integrator is not efficient for capturing a circular light converging spot. Therefore, the rod integrator may be tapered or flared, and the size of the light incident surface of the rod integrator assigned to one light source may be set so as to represent almost a square. However, attention should be paid to the following matters. When the rod integrator is tapered or flared, a distortion may occur in an angular distribution after light beams are emitted from the rod integrator, which may cause loss in an optical system provided for a process following the light emission from the rod integrator. Therefore, a balance should be considered for setting.

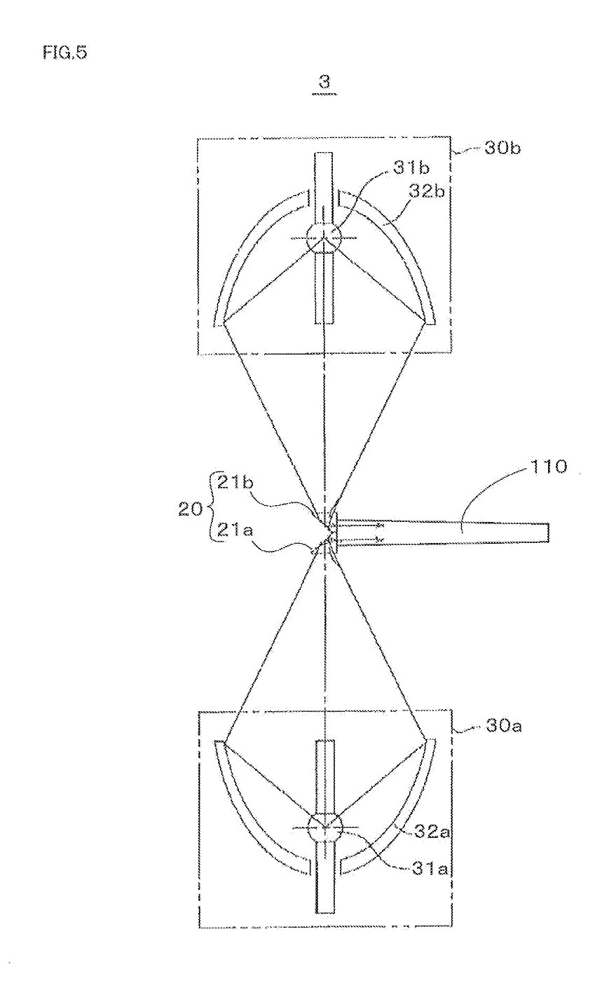

FIG. 5 is a diagram illustrating a main portion of an illumination optical device 3 according to a second modification.

As shown in FIG. 5, in the illumination optical device 3 according to the second modification, a rod integrator 110 is used instead of the rod integrator 10 of the illumination optical device 1.

The rod integrator 110 is tapered. Therefore, in the rod integrator 110, the size of the light incident surface and the size of the light exit surface are different from each other. The cross-section of the rod integrator which is parallel to the light exit surface and the light incident surface has a rectangular shape, and the shape of the cross-section approaches a square by extending the short sides of the rectangular shape toward the light incident surface, so that the shape of the light incident surface becomes almost a square.

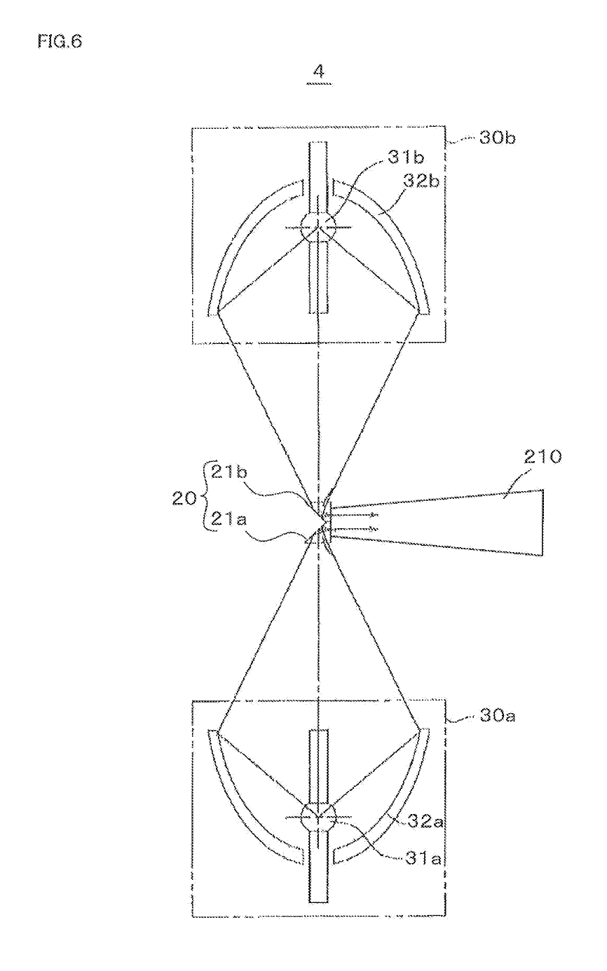

FIG. 6 is a diagram illustrating a main portion of an illumination optical device 4 according to the second modification.

As shown in FIG. 6, in the illumination optical device 4 according to the second modification, a rod integrator 210 is used instead of the rod integrator 10 of the illumination optical device 1.

The rod integrator 210 is flared. Therefore, in the rod integrator 210, the size of the light incident surface and the size of the light exit surface are different from each other. The cross-section of the rod integrator which is parallel to the light exit surface and the light incident surface has a rectangular shape, and the shape of the cross-section approaches a square by shortening the long sides of the rectangular shape toward the light incident surface, so that the shape of the light incident surface becomes almost a square.

[Third Modification]

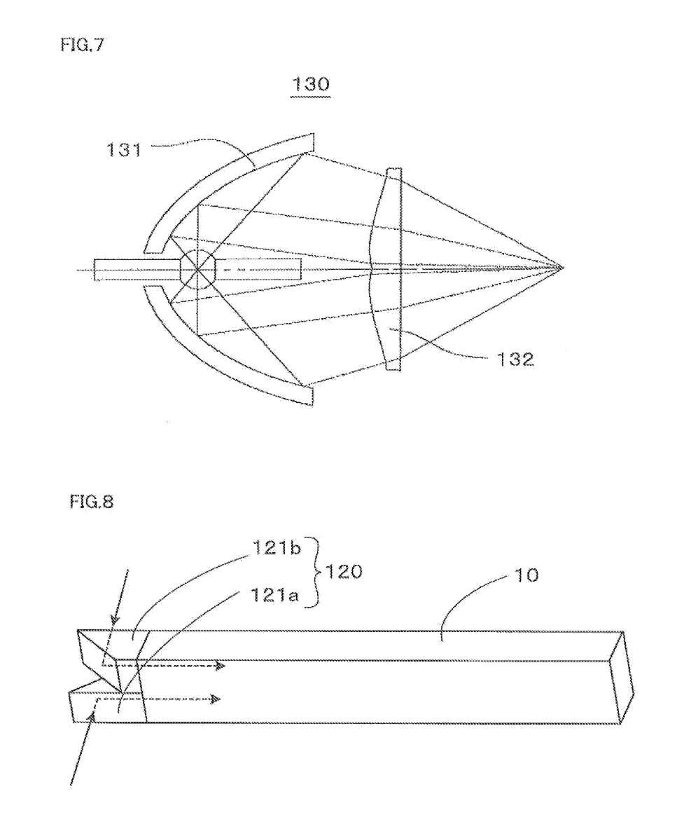

FIG. 7 is a diagram illustrating a main portion of a light source unit 130 according to a third modification.

As described above, a concave mirror which has a cross section of which the shape is a portion of an ellipse and has a reflecting surface formed thereon is used, and a light source is positioned at the first focus, thereby enabling light beams to be converged on the second focus. However, a high-order aspheric concave mirror 131 which has a cross section of which the shape is a portion of a deformed ellipse, and has a reflecting surface formed thereon, and an aspheric light converging lens 132 which is concave at the center portion may be combined with each other in order to enhance a light converging efficiency, as shown in FIG. 7.

[Fourth Modification]

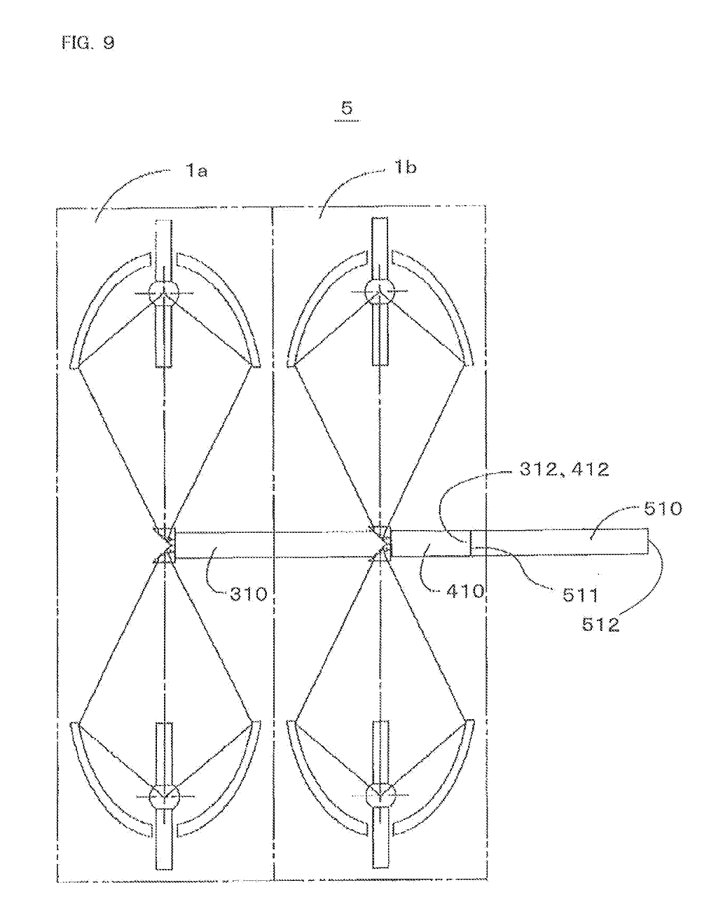

FIG. 8 is a diagram illustrating a main portion of a light guiding section 120 according to a fourth modification.

As shown in FIG. 8, the light guiding section 120 is structured such that two right-angled trapezoidal prisms 121a and 121b are placed one on top of the other such that the trapezoidal surfaces of two right-angled trapezoidal prisms 121a and 121b are staggered, and the light incident surfaces are oriented in opposite facing directions.

The optical axes of the two right-angled trapezoidal prisms 121a and 121b are parallel to each other, and the efficiency can be improved as compared to in the conventional art. However, unlike in the first embodiment, the optical axes thereof are not identical. Therefore, the probability for reuse of the light beams is reduced as compared to in the structure according to the first embodiment.

### Second Embodiment

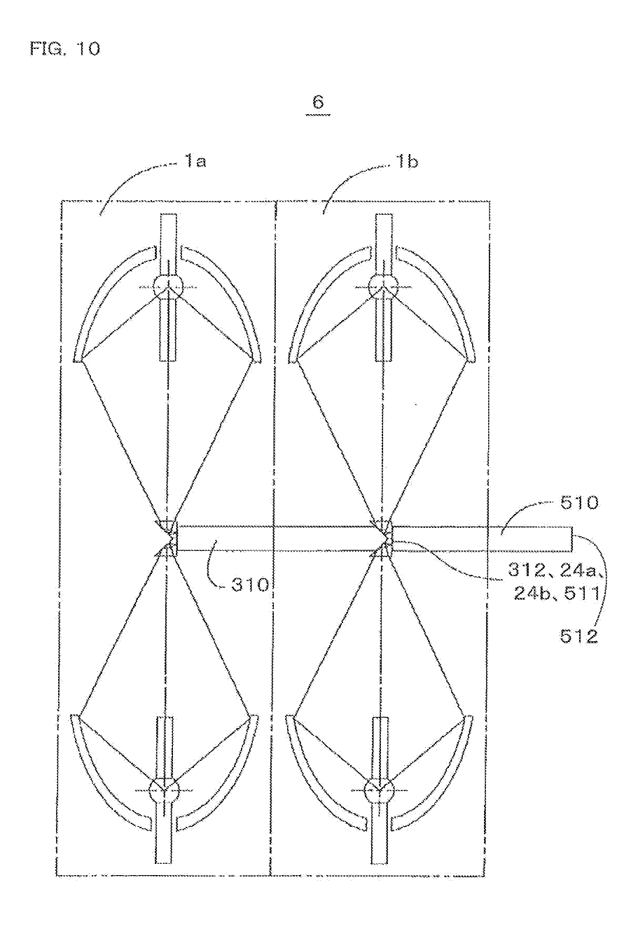

FIG. 9 is a diagram illustrating a main portion of an illumination optical device 5 according to a second embodiment.

As shown in FIG. 9, the illumination optical device 5 includes two illumination optical devices 1 (1a and 1b) according to the first embodiment. Subsidiary rod integrators 310 and 410 each having the same structure as the rod integrator 10 are used as the rod integrators for the illumination optical devices 1a and 1b, respectively. Light exit surfaces 312 and 412 of the subsidiary rod integrators 310 and 410, respectively, are aligned, and are connected to a light incident surface 511 of a main rod integrator 510, which is additionally provided.

The length of the subsidiary rod integrator 310 and the length of the subsidiary rod integrator 410 are different from each other. The subsidiary rod integrator 310 and the subsidiary rod integrator 410 are aligned in parallel to each other, and the positions of the light exit surfaces thereof are aligned. Further, the light exit surface 312 of the subsidiary rod integrator 310 and the light exit surface 412 of the subsidiary rod integrator 410 are positioned so as to be in contact with the light incident surface 511 of the main rod integrator 510. Further, the total size of both the light exit surface 312 and the light exit surface 412 is set so as to be almost equal to the size of the light incident surface 511. At least one of the subsidiary rod integrator 310, the subsidiary rod integrator 410, and the main rod integrator 510 may be tapered or flared such that the size of the light incident surface and the size of the light exit surface are different in the tapered or flared rod integrator, as in the second modification.

Light incident on the main rod integrator 510 is totally reflected in a medium multiple times, and the light becomes uniform in illumination distribution at the light exit surface 512 of the main rod integrator 510, and is emitted from the light exit surface 512. Thus, light beams from a plurality of light sources can be synthesized in a non-wasteful manner, thereby enabling the illumination optical device to enhance the brightness.

In the present embodiment, light beams from four light sources are synthesized. However, when n illumination optical devices according to the first embodiment are provided and connected as described above, light beams from 2×n light sources can be synthesized.

[Fifth Modification]

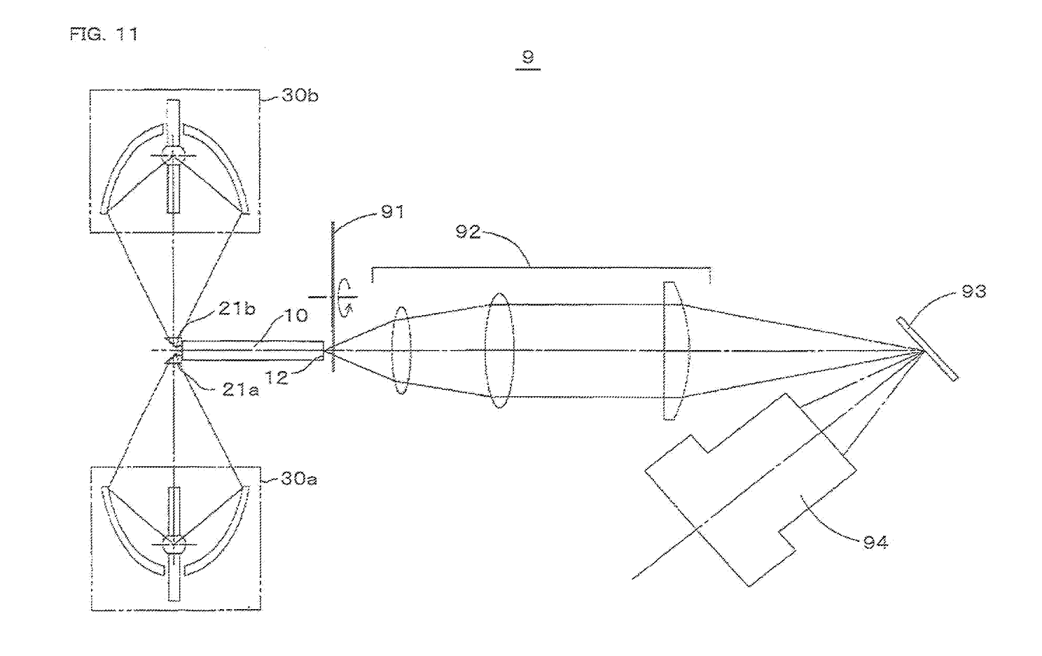

FIG. 10 is a diagram illustrating a main portion of an illumination optical device 6 according to a fifth modification.

As shown in FIG. 10, the illumination optical device 6 has the same structure as the illumination optical device 5 according to the second embodiment except that the subsidiary rod integrator 410 is not provided, and the main rod integrator 510 also acts as the subsidiary rod integrator 410.

In the illumination optical device 6 which has no subsidiary rod integrator 410 provided therein, the first light exit surface 24a and the second light exit surface 24b of the light guiding section 120 are positioned so as to be in contact with the light incident surface 511 of the main rod integrator 510. Therefore, this structure may be regarded as the second embodiment in which the length of the subsidiary rod integrator 410 is zero.

### Third Embodiment

FIG. 11 is a diagram illustrating a main portion of a projection display device 9 according to a third embodiment.

As shown in FIG. 11, the projection display device 9 according to the third embodiment includes: the illumination optical device 1 according to the first embodiment; a color wheel 91; a lens unit 92; a DMD 93; and a projection lens 94.

The color wheel 91 is a rotatable member in which three kinds of color filters each of which transmits a corresponding one of three primary colors of red, green, and blue, are sequentially switched. White light emitted from the illumination optical device 1 is time-divided into three primary color light beams through the color wheel 91.

The lens unit 92 includes a plurality of lenses, and is operable to guide red light beams, green light beams, and blue light beams having been transmitted through the color wheel 91 so as to be incident on the DMD 93 with appropriate sizes.

The DMD 93 is a kind of display device which has multiple micro-minors aligned in a planar manner. The DMD 93 generates an output video image by switching each of the incident red light beams, green light beams, and blue light beams which have been obtained through time-division, between a display state and a non-display state, for each pixel, based on an image control signal from the outside.

The projection lens 94 forms, on a screen (not shown), the output video image generated by the DMD 93.

Note that some or all of the embodiments and modifications may be combined as necessary if no contradiction arises.

The illumination optical device according to the present invention is applicable to a projection display device such as a liquid crystal projector and a DLP projector, and is greatly useful because a light converging efficiency can be enhanced, and the brightness of a projected image can be enhanced without reducing the life of a light source and significantly increasing cost, when light beams emitted from a plurality of light sources are synthesized.

What is claimed is:

1. An illumination optical device comprising:
a rod integrator for eliminating a non-uniformity in an illumination of incident light which is incident on a light incident surface of the rod integrator, and for emitting, from a light exit surface of the rod integrator, illumination light in which an illumination distribution is uniform;
a light guiding section for guiding a portion of first incident light beams incident on a first light incident surface of the light guiding section, to the light incident surface of the rod integrator, and for transmitting through the light guiding section and emitting from a second light incident surface of the light guiding section another portion of the first incident light beams, and for guiding a portion of second incident light beams incident on the second light incident surface of the light guiding section, to the light incident surface of the rod integrator, and for transmitting through the light guiding section and emitting from the first light incident surface of the light guiding section another portion of the second incident light beams;
a first light source and a second light source opposing each other so as to be symmetrical with respect to the light guiding section;
a first light converging section for converging light beams which are directly emitted from the first light source, and for converging light beams which have been transmitted through the light guiding section and emitted from the first light incident surface such that a converged light is incident on the first light incident surface; and
a second light converging section for converging light beams which are directly emitted from the second light source, and for converging light beams which have been transmitted through the light guiding section and emitted from the second light incident surface such that a converged light is incident on the second light incident surface.

2. The illumination optical device according to claim 1, wherein
the light guiding section includes a first right-angled trapezoidal prism and a second right-angled trapezoidal prism,
the first light incident surface includes a long side of a first trapezoid in the first right-angled trapezoidal prism, and the first light incident surface is opposed to the first light source,
the second light incident surface includes a long side of a second trapezoid in the second right-angled trapezoidal prism, and the second light incident surface is opposed to the second light source,
the angle between the first light incident surface, and a first reflecting surface including an oblique side of the first trapezoid, and the angle between the second light incident surface, and a second reflecting surface including an oblique side of the second trapezoid, are each almost 45 degrees,
a first light exit surface including a side between right angles of the first trapezoid, and a second light exit surface including a side between right angles of the second trapezoid are each in contact with the light incident surface of the rod integrator, and
a first light transmission surface including a short side of the first trapezoid and a second light transmission surface including a short side of the second trapezoid are in contact with each other, and the portion of the first incident light beams and the portion of the second incident light beams are transmitted through the first light transmission surface and the second light transmission surface.

3. The illumination optical device according to claim 2, wherein, in the light guiding section, the first right-angled trapezoidal prism and the second right-angled trapezoidal prism are integrated into one component by connecting the first light transmission surface and the second light transmission surface.

4. The illumination optical device according to claim 1, wherein a size of a light converging spot for each of the first light converging section and the second light converging section is greater than half a size of the light incident surface of the rod integrator.

5. The illumination optical device according to claim 1, further comprising a first reflector and a second reflector, provided on the first light incident surface and the second light incident surface, respectively, outside effective surfaces on which the incident light is effectively utilized, wherein the first reflector and the second reflector reflect light outside of the effective surfaces of the first light incident surface and the second light incident surface, respectively.

6. The illumination optical device according to claim 1, wherein the rod integrator is tapered or flared such that a size of the light incident surface of the rod integrator and a size of the light exit surface of the rod integrator are different from each other.

7. An illumination optical device comprising:
a plurality of illumination optical devices according to claim 1; and
one main rod integrator, wherein
the plurality of illumination optical devices includes a plurality of subsidiary rod integrators, respectively, each of which corresponds to the rod integrator according to claim 1; and
light exit surfaces of the plurality of subsidiary rod integrators are aligned, and are connected to a light incident surface of the one main rod integrator.

8. The illumination optical device according to claim 7, wherein at least one of the one main rod integrator and the plurality of subsidiary rod integrators is tapered or flared, and a size of a light incident surface of the at least one tapered or flared rod integrator and a size of a light exit surface of the at least one tapered or flared rod integrator are different from each other.

9. The illumination optical device according to claim 7, wherein the one main rod integrator acts as one of the plurality of subsidiary rod integrators without providing the one of the plurality of subsidiary rod integrators.

10. The illumination optical device according to claim 9, wherein at least one of the one main rod integrator and the plurality of subsidiary rod integrators is tapered or flared, and a size of a light incident surface of the at least one tapered or flared rod integrator and a size of a light exit surface of the at least one tapered or flared rod integrator are different from each other.

11. A projection display device comprising the illumination optical device according to claim 1.

12. A projection display device comprising the illumination optical device according to claim 2.

13. A projection display device comprising the illumination optical device according to claim 3.

14. A projection display device comprising the illumination optical device according to claim 4.

15. A projection display device comprising the illumination optical device according to claim 5.

16. A projection display device comprising the illumination optical device according to claim 6.

17. A projection display device comprising the illumination optical device according to claim 7.

18. A projection display device comprising the illumination optical device according to claim 8.

19. A projection display device comprising the illumination optical device according to claim 9.

20. A projection display device comprising the illumination optical device according to claim 10.
